(19) United States
(12) Patent Application Publication
(10) Pub. No.: US 2006/0044189 A1
(43) Pub. Date: Mar. 2, 2006

(54) Radome structure

(76) Inventors: Stan W. Livingston, Fullerton, CA (US); Jar J. Lee, Irvine, CA (US); Richard J. Koenig, Buena Park, CA (US)

Correspondence Address: PATENT DOCKET ADMINISTRATION;RAYTHEON SYSTEMS COMPANY, P.O. BOX 902 (E1/E150), BLDG E1 M S E150, EL SEGUNDO, CA, 90245-0902, US

(21) Appl. No.: 10/931,574

(22) Filed: Sep. 1, 2004

(51) Int. Cl. H01Q 1/38

(52) U.S. Cl. 343/700 MS

(57) ABSTRACT

A radome structure is fabricated of spaced layers of conductive patches, wherein sets of conductive patches of the layers in a direction transverse to a lateral extent of the layers have a decreasing lateral extent to form a waveguiding structure.

### BACKGROUND

Conventional wide band phased arrays use discrete tapered radiating elements to match the low impedance of the input feed lines to the high impedance (377 ohm) of free space. The flares usually are costly to machine or fabricate and can limit the system integration options of a phased array aperture. This invention replaces the discrete flares or tapers with a laminated dielectric radome loaded with conducting patches made from simple printed circuit technology. The planar geometry drastically reduces the production cost and allows mechanical freedom associated with laminates otherwise unavailable to the state of the art.

Wide band arrays, e.g., with greater than 3:1 bandwidth, typically can be complicated and expensive structures. Flared dipoles or tapered slots are attached to feed lines intricately in a 3-D manner for a typical phased array as necessary for impedance match between the feed lines and free space. The complex fabrication assembly and interface to feed lines add cost and weight to the aperture. Patch arrays or other printed circuit board arrays have been used to lower costs by taking advantage of photo lithography techniques. However, these printed techniques have been limited in bandwidth.

### SUMMARY OF THE DISCLOSURE

A radome structure is fabricated of spaced layers of conductive patches, wherein sets of conductive patches of said layers in a direction transverse to a lateral extent of the layers have a decreasing lateral extent to form a waveguiding structure.

### BRIEF DESCRIPTION OF THE DRAWINGS

Features and advantages of the disclosure will readily be appreciated by persons skilled in the art from the following detailed description when read in conjunction with the drawing wherein:

FIG. 1 is a diagrammatic cross-sectional view of an embodiment of an antenna array employing a laminated matching radome.

FIG. 2 is an isometric diagrammatic view of a laminated radome structure.

FIG. 3 is a simplified schematic diagram illustrating the radome excitation network of FIG. 1.

FIG. 4 shows an alternate technique of exciting the radome structure, using a dipole feed network.

FIG. 5 shows another alternate technique of exciting the radome structure, using a loop feed network.

FIG. 6 is a diagrammatic isometric view of an alternate embodiment of a laminated radome structure.

### DETAILED DESCRIPTION

In the following detailed description and in the several figures of the drawing, like elements are identified with like reference numerals.

In an exemplary embodiment of a radome structure, solid discrete radiating elements are eliminated by using laminated, multi-layer, planar, printed circuits. With laminated layers and photolithography production techniques, the geometry can reduce the production costs, in one embodiment similar to integrated circuit wafer production. In an exemplary embodiment, cost and weight can be substantially reduced without limiting the bandwidth of the array using printed circuit board technology. In an exemplary embodiment for lower frequencies and larger structures, using thin polyamid KaptonJ interleaved between foam to provide a wide band array can significantly lower the weight of a phased array antenna. The lowest frequency depends on the allowable depth of the system which is a tradeoff with bandwidth. The highest practice frequency would depend on the interface electronic performance and the smallest achievable spacing between the layers. The operating frequency may be as high as W-Band. An example of the W-band interfacing electronics and semiconductor fabrication is described in U.S. Pat. No. 6,157,347.

In one embodiment, a phased array can be fabricated with low cost multi-layered circuit board technology using photolithography techniques. This phased array antenna may provide 2-D electronic scan over a wide scan volume and wide band, if the elements in the radome are each connected to an active electronic module. Production costs can be reduced. Multiple layer techniques can be used to construct a corrugated radome structure to guide the wave propagating from the array aperture to free space efficiently. The techniques are applicable to single or dual polarizations.

A radome structure can replace the traditional egg crate array of discreet solid radiators, such as tapered slots or flared dipoles. An exemplary embodiment of a dielectric radome laminated with layers of printed foil conductors on extremely thin polyamid KaptonJ sandwiched between foam is very light, flexible, and can be made conformal to special curvatures or configurations.

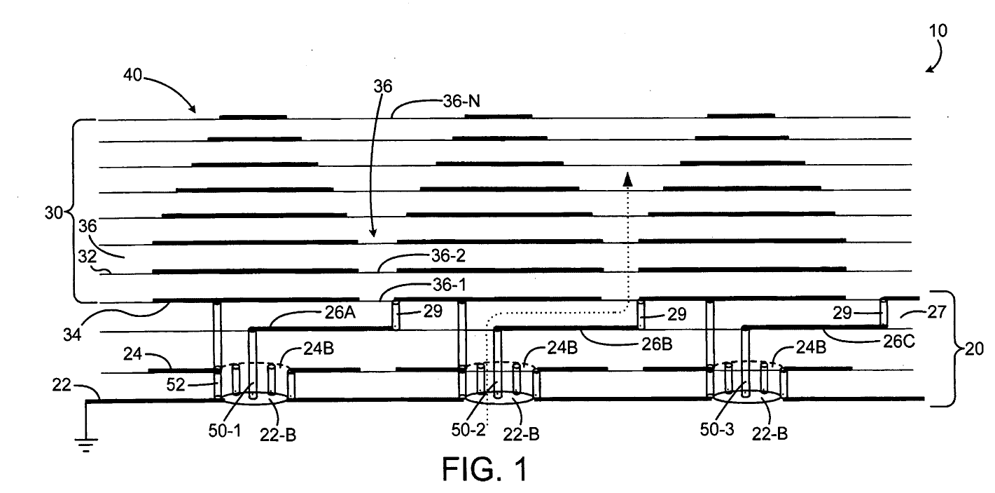

An exemplary embodiment of a phased array antenna 10 is illustrated in FIG. 1, which shows a diagrammatic cross-sectional view of a portion of the antenna array 10. The antenna includes a wide band radome structure 30, which may be fabricated of layers of dielectric media 32 on which conductive foil patches 34 are formed. In an exemplary embodiment, the layers can be spaced by dielectric spacer layers 36, e.g. foam or other dielectric layers, e.g. layers compatible with integrated circuit production as an example. The efficiency of antenna arrays fabricated on integrated circuit wafers can benefit with a matching radome which can be deposited as extra layers during wafer production, in an exemplary embodiment.

In an exemplary embodiment, the layers are dense enough with respect to the operating wavelength to form a pyramidal waveguide structure 40, which presents a matching transmission impedance for the wave to propagate from the aperture to the free space. An exemplary spacing between layers is 1/10 wavelength, although spacings smaller or greater than 1/10 wavelength can be employed, depending on the application. In an exemplary embodiment, multiple layer printed circuit technology is used to fabricate a three dimensional (3-D) corrugated structure for efficient radiation, wherein each layer of the array of patches is deposited down one after the other between the layers of dielectric. A two dimensional planar fabrication process such as printed circuit board or semiconductor wafer technology can be used in multiple steps to form sequentially one layer on top of the next to form three dimensional RF waveguide structures for each unit cell of the element of the radome. The geometry repeats, typically about half wave or less, although a larger spacing can be employed; this basic building block is called the unit cell in phased array technology.

A corrugated transmission line structure can support broadband (e.g. in one embodiment, >10:1) operation. The transmission structure enables a signal to propagate in the bore-sight direction due to the boundary conditions of the unit cell lattice of the elements in a large array. Therefore, the spacing between the radiators, typically less than a wavelength, is a design criterion. The unit cell spacing is the spacing between the tips of adjacent pyramids, each unit cell containing one radiator, which radiates RF energy from the circuit waveguide to free space. This small unit cell spacing allows the radiating elements to be individually excited with an arbitrary phase front, so that two-dimensional (2-D) beam scans may be achieved for many communication and radar applications. The slot width is the gap inside the radiator throat, which increases to be larger at the tips. Depending on the application, the parameters of the radome structure can be optimized by the designer, depending on tradeoffs such as gain and scan volume.

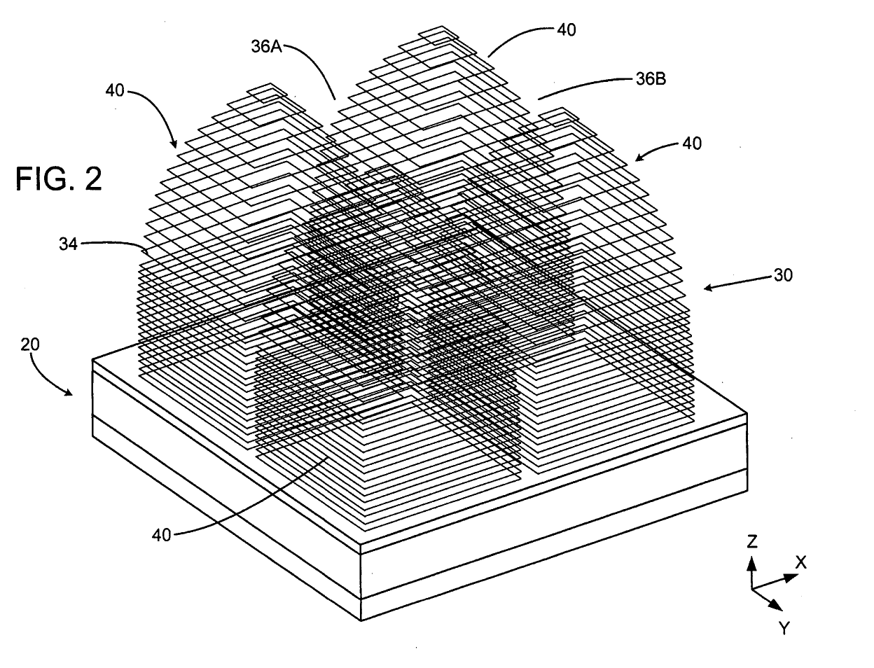

FIG. 2 is an isometric diagrammatic view of a portion of an exemplary laminated radome structure 30, which shows a square lattice of four exemplary pyramidal structures 40. For simplicity, only the conductive patches 34 of the radome structure are illustrated in FIG. 2; the dielectric layers separating the layers of the patches are not shown. The radome structure is mounted on a feed layer assembly 20.

The laminated radome structure 30 forms a transmission medium, which matches the low impedance of a radiating long slot 36 to the high impedance of the free space. The impedances are determined by the slot and feed line dimensions on one side, and the lattice spacing on the other, typically 50 ohms and 377 ohms, respectively, with a square lattice of the pyramidal structure 40. The feed lines 50-1, 50-2, 50-3 at the interface each excite a respective low impedance slot gap, e.g. gap 36-1 corresponding to feed line 50-1, on the first layer. The slot gaps 36-2 . . . 36-N on subsequent layers are increased to taper the characteristic impedance of the corrugated transmission line from low to high impedance. Impedance tapers such as described by R. W. Klopfenstein, “A Transmission Line Taper Of Improved Design,” Proc. IRE, January 1956, pages 31-35; or R. E. Collin, “The Optimum Tapered Transmission Line Matching Section,” Proc. IRE, April 1956, pages 539-548, can be used for wide band applications. The pyramidal waveguide structure, in an exemplary embodiment, is designed to present a matching transmission impedance for an electromagnetic wave to propagate from the aperture to the free space. This can be done by selecting the depth of the slot between the pyramidal structures and changing of the gap width to change the impedance per unit length, e.g. as described in the paper “The Optimum Tapered Transmission Line Matching Section@ paper, which describes the depth required depending on the bandwidth of the particular design.

The “flare” formed in the tapered unit cell element is not a solid 3-D flare as described in U.S. Pat. No. 5,428,364, or U.S. Pat. No. 6,127,984. In an exemplary embodiment, the tapered unit cell element is a laminated structure with thin metal foils 34 in the x-y plane, normal to the propagation direction. The metal foil may printed on a thin substrate 32 such as polyamide KaptonJ (0.003″ inch typically), which is interleaved between lightweight substrates 36 of light low-k foam material. Alternatively, the layers of dielectric and metal foils can be fabricated on a dielectric substrate using integrated circuit (IC) wafer production techniques. The semiconductor dielectric may be silicon, gallium arsenide, or indium phosphide, for example. A first conductive layer is formed on the surfaces of the semiconductor substrate, then alternating layers of semiconductor dielectric and or oxide layers with conductive layers to form the wave guiding regions.

In the exemplary embodiment illustrated in FIG. 1, the array is excited by energy carried by the feed lines 50-1, 50-2, 50-3 . . . , which comprise a coaxial interface to a respective slot, e.g. slot 36 in a feed layer assembly 20. The feed layer assembly in this exemplary embodiment comprises a conductive ground layer 22 formed on a thin dielectric layer 22A. Circular openings 22B are formed in the bottom ground plane layer. The feed layer assembly further includes successive layers 24, 26, with layer 24 forming another ground plane with circular openings 24B formed in the conductive ground plane layer in correspondence with the openings 22B in the bottom ground plane layer 22. The respective layers 22, 24, 26 are separated by dielectric layers, e.g. light low-k foam material substrates. The feed lines are surrounded by a plurality of vertical conductive, plated through vias 52 which extend between the layers 22, 24 to form the coaxial outer shield surrounding the feed lines, e.g. line 50-1. The second ground plane is an optional fine adjustment feature, used to make the cavity behind the radiator look bigger. The spacing between layers 34 and 26 depends on the impedance of the microstrip line 26 which can be chosen by the designer to interface to the rest of the system. The spacing for a given application can be readily calculated, using techniques well known in microstrip circuit design.

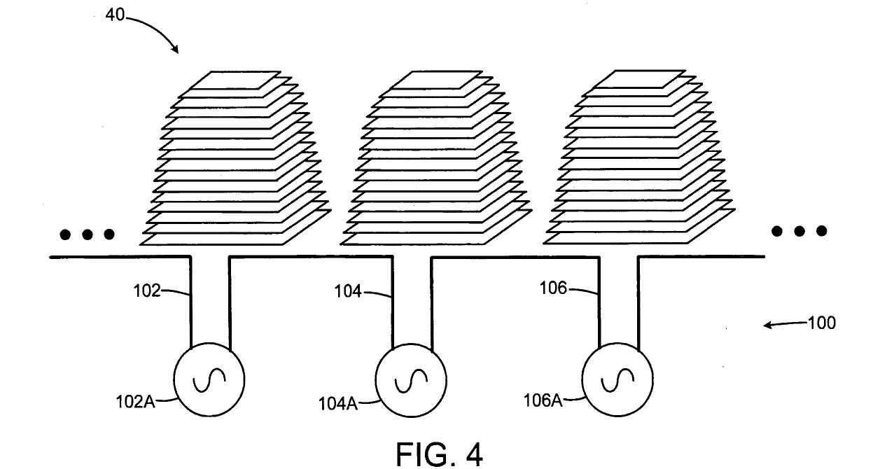

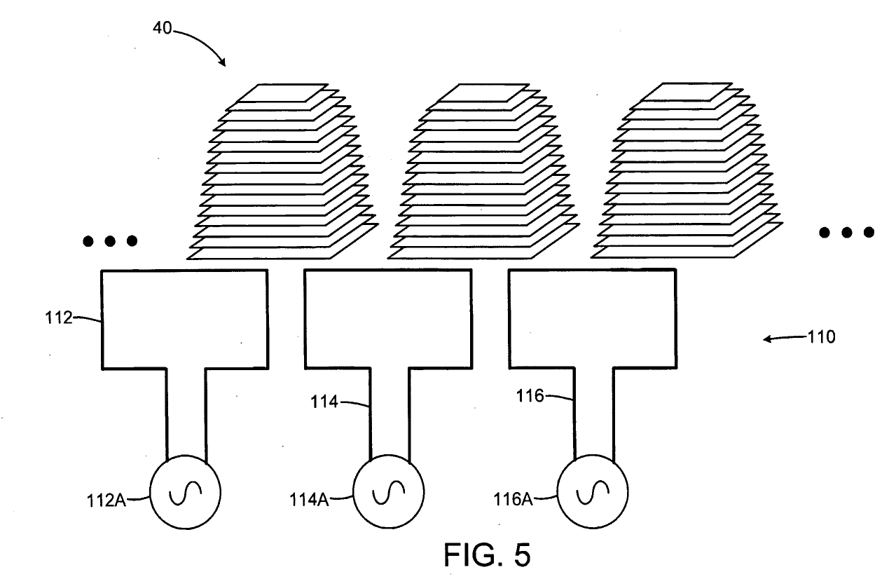

In an exemplary embodiment, the feed lines extend through the openings in the ground planes 22, 24 to microstrip layer 26, where each feed line is connected to a microstrip conductor. Thus, feed line 50-1 is connected to an end of microstrip conductor 26A, feed line 50-2 to an end of microstrip conductor 26B and feed line 50-3 to an end of microstrip conductor 26C. The distal ends of the respective microstrip conductors are respectively connected to plated through vias 29 formed in a dielectric layer 27 separating layer 26 from layer 32 of the radome structure 30. The vias 29 connect to an edge of a foil patch 34 on layer 32. Ground vias 52 extend from layer 24 up to layer 32 to electrically connect to foil patch 34 at a location spatially separated from the connection of the feed line. The spacing between the unit cells is large enough to provide transited delay between the excitation and the ground paths so they are not shorted. In other embodiments, e.g. the embodiments of FIGS. 4 and 5, the foil patches may not even contact either the feed or the ground, which may be desirable for some fabrication processes where vertical interconnects are difficult to achieve.

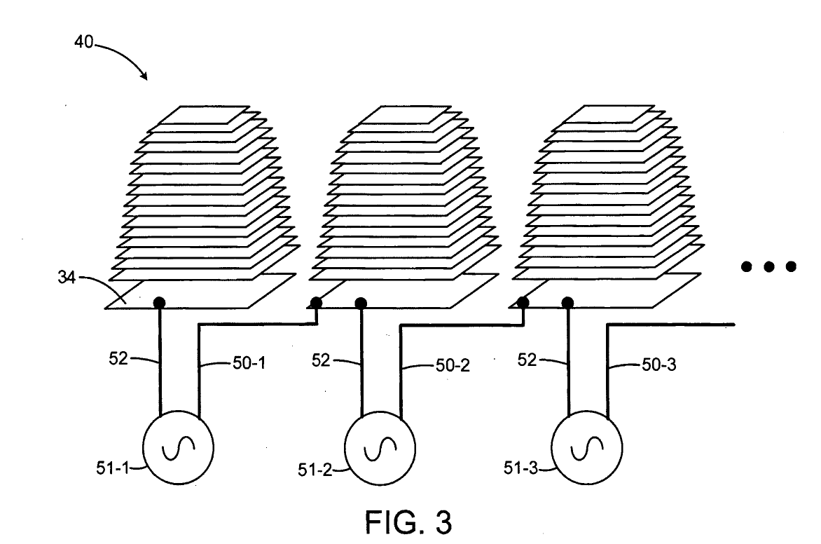

FIG. 3 is a simplified schematic diagram illustrating the radome excitation network comprising patches 34 connected by coaxial feed lines 50-1, 50-2, 50-3, . . . , and ground lines 52 to a corresponding excitation source 51-1, 51-2, 51-3.

The radome structure 30 can be excited in various ways other than the coaxial feed lines illustrated in FIGS. 1 and 3. For example, the radome structure can be excited by a dipole feed network, as generally illustrated in FIG. 4. Here, the slots between the pyramid structures 40 are excited with a dipole feed network 100 comprising dipoles 102, 104, 106 . . . , each driven by a corresponding excitation source 102A, 104A, 106A . . . The excitation sources in an exemplary embodiment may be the outputs of active electronic circuits in T/R modules; the T/R modules can form the load in the reciprocity case of receive operation.

FIG. 4 shows an alternate technique of exciting the radome structure, using a dipole feed network 100 comprising dipoles 102, 104, 106, . . . each respective driven by a corresponding excitation source 102A, 104A, 106A . . .

FIG. 5 shows another alternate technique of exciting the radome structure, using a loop feed network 110 comprising loops 112, 114, 116, . . . each respective driven by a corresponding excitation source 112A, 114A, 116A . . .

The excitation circuits illustrated in FIGS. 4 and 5 can excite the radome structure, and in these cases the foil patches are not even contacting either the feed or the ground, which may be desirable in some fabrication process where vertical interconnects are difficult to accomplish such as in integrated circuit wafer production.

In an exemplary embodiment, the radome structure comprises a corrugated transmission line structure, formed in a periodic array environment. In such a lattice, the ideal unit cell defined by two parallel electric walls (top and bottom) and two parallel magnetic walls on the sides prevents signal flow in X and Y directions. The boundary conditions imposed by a uniformly periodic array, magnetic and electric walls, prevent the lateral flow of signal and force the signal to propagate in the Z direction, as long as the unit cell is less than a wavelength and the unit cell repeats itself at least to an aperture size of several wavelengths large. In one exemplary embodiment, the gap between the laminated layers is approximately 6% of center band wavelength, yet not necessarily limited to this thickness as long as the resulting efficiency is acceptable.

In an exemplary embodiment, plating thin Kapton (0.003″ thick) with square patches can form the metal foils on the layers comprising the corrugated transmission line. For an exemplary embodiment, depending on the bandwidth of the particular design, each layer of patches is separated by a spacing, e.g. 1/10 wavelength, so the number of layers will depend on the depth required to match in terms of wavelengths multiplied by 10 for this example. Foam material may be used to build up the layers to support the metal foils; however, other low-k dielectric substrates are also acceptable. Foam is one desirable material due to its lightweight and low dielectric constant. A low dielectric constant is preferred for the radome in order to reduce the weight and lensing (dielectric loading) effect, so that a sparse lattice may be used to achieve grating lobe free 2-D scans. The spacing between each layer of patches can vary, depending on the application. Some applications may employ spacings which are less than 1/10 wavelength; other applications may employ spacings which are greater than 1/10 wavelength. The spacing between patch layers will typically be a fraction of an operating wavelength.

Simulation shows that an exemplary embodiment of a guiding flared structure, i.e. the pyramid structure, can yield a good VSWR input match over a 4:1 bandwidth. Other embodiments may provide different matches.

Tapering the corrugated flared structure effectively forms a pyramidal radiating element. A taper length, i.e. height of the pyramid structure, of 2 wave length at the mid-band may be sufficient to provide a large 4:1 bandwidth. The paper, R. W. Klopfenstein, “A Transmission Line Taper of Improved Design,” Proc. IRE, January 1956, pages 31-35, describes an exemplary technique for determining the depth required depending on the bandwidth of the particular design.

This radome architecture can provide dual polarization by interleaving two orthogonal sets of slots and feeding the slots accordingly as described above for the embodiment of FIG. 1. FIG. 2 illustrates a portion of a radome structure for the two dimensional case, wherein the gaps or slots or channels between the foil patches run in both the X and Y direction. Thus, slots 36A run in the Y direction, and slots 36B run in the X direction.

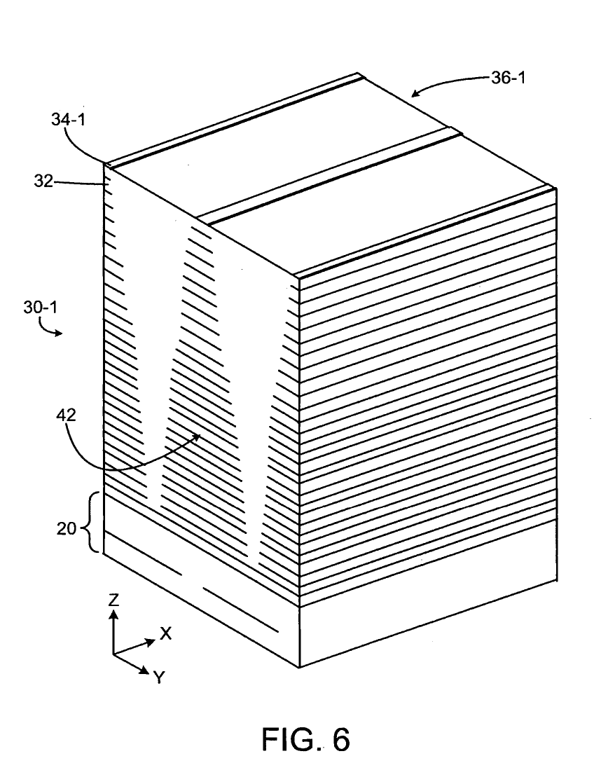

FIG. 6 diagrammatically illustrates a portion of an alternate embodiment of a radome structure 30-1 for a single or linear polarization antenna. This embodiment is similar to that shown in FIG. 2, with conductive patches 34-1 interleaved between dielectric layers 32, assembled to a feed layer assembly 20. In this single polarization case, the conductive patches extend continuously along the X direction, and are of decreasing width in the Y direction to form a generally triangular structure 42 in the Z direction, with channels 36-1 between the triangular structures. The feed layer assembly 20 can be of the type illustrated in FIG. 1 or 3-5.

In one exemplary embodiment, the antenna array has an operating frequency range between 4-13 GHz.

Although the foregoing has been a description and illustration of specific embodiments of the invention, various modifications and changes thereto can be made by persons skilled in the art without departing from the scope and spirit of the invention as defined by the following claims.

What is claimed is:

1. A phased array antenna, comprising:
a radome structure forming an array aperture, fabricated of spaced layers of conductive patches, wherein sets of conductive patches of said layers in a direction transverse to a lateral extent of the layers have a decreasing lateral extent to form a waveguiding structure.

2. The antenna of claim 1, wherein said radome structure presents a matching transmission impedance for an electromagnetic wave to propagate from the aperture to free space.

3. The antenna of claim 1, wherein the radome structure further comprises dielectric spacer layers sandwiched between adjacent layers of said conductive patches.

4. The antenna of claim 1, wherein said radome structure provides a three dimensional (3-D) corrugated transmission structure.

5. The antenna of claim 1, wherein said conductive patches form an array of pyramidal waveguide structures.

6. The antenna of claim 1, wherein said conductive patches have a continuous extent along said lateral extent of said layers.

7. The antenna of claim 1, further comprising a feed network for exciting the radome structure.

8. The antenna of claim 7, wherein the feed network comprises a plurality of coaxial feed interfaces each including a coaxial feed line coupled to a patch.

9. The antenna of claim 7, wherein the feed network comprises a plurality of loops and corresponding excitation sources.

10. The antenna of claim 7, wherein the feed network comprises a dipole network comprising a plurality of dipoles and excitation sources.

11. The antenna of claim 1, wherein said layers are spaced by 1/10 wavelength or less at an operating frequency of the antenna.

12. The antenna of claim 1, wherein a plurality of sets of said patches form a plurality of pyramidal waveguide structures.

13. The antenna of claim 12, wherein said waveguide structures repeat along an axis at a spacing.

14. The antenna of claim 13, wherein said spacing is one half wavelength or less at an operating wavelength.

15. The antenna of claim 12, wherein said pyramidal waveguide structures repeat along two orthogonal axes.

16. The antenna of claim 6, wherein said sets of conductive patches repeat along a single axis.

17. A phased array antenna, comprising:
a radome structure for an array aperture, fabricated of laminated layers of dielectric media on which conductive patches are formed, wherein sets of conductive patches on said layers in a direction transverse to a lateral extent of the layers form a waveguiding structure.

18. The antenna of claim 17, wherein said radome structure presents a matching transmission impedance for an electromagnetic wave to propagate from the aperture to free space.

19. The antenna of claim 17, wherein the radome structure further comprises dielectric spacer layers sandwiched between adjacent layers of said dielectric media.

20. The antenna of claim 17, wherein said radome structure provides a three dimensional (3-D) corrugated transmission structure for efficient radiation.

21. The antenna of claim 17, wherein said conductive patches form an array of pyramidal waveguide structures.

22. The antenna of claim 17, wherein said conductive patches have a continuous extent along said lateral extent of said layers.

23. The antenna of claim 17, further comprising a feed network for exciting the radome structure.

24. The antenna of claim 23, wherein the feed network comprises a plurality of coaxial feed interfaces each including a coaxial feed line coupled to a patch.

25. The antenna of claim 23, wherein the feed network comprises a plurality of loops and corresponding excitation sources.

26. The antenna of claim 23, wherein the feed network comprises a dipole network comprising a plurality of dipoles and excitation sources.

27. The antenna of claim 17, wherein said layers are spaced by 6% of a wavelength at a band center frequency of the antenna.

28. The antenna of claim 17, wherein a plurality of sets of said patches form a plurality of pyramidal waveguide structures.

29. The antenna of claim 28, wherein said waveguide structures repeat along an axis at a spacing.

30. The antenna of claim 29, wherein said spacing is one half wavelength or less at an operating wavelength.

31. The antenna of claim 29, wherein said pyramidal waveguide structures repeat along two orthogonal axes.

32. A radome structure for an antenna, comprising:
laminated layers of dielectric media on which conductive patches are formed, wherein sets of conductive patches on said layers in a direction transverse to a lateral extent of the layers form a pyramidal waveguide structure.

33. The structure of claim 32, wherein said laminated layers form an array aperture.

34. The structure of claim 33, wherein said radome structure presents a matching transmission impedance for an electromagnetic wave to propagate from the aperture to free space.

35. The structure of claim 32, further comprising dielectric spacer layers respectively sandwiched between adjacent layers of said dielectric media.

36. The structure of claim 32, wherein said radome structure provides a three dimensional (3-D) corrugated transmission structure.

37. The structure of claim 32, wherein said conductive patches form an array of said pyramidal waveguide structures.

38. The structure of claim 32, wherein said layers are spaced by 1/10 wavelength or less at an operating frequency of the antenna.

39. The structure of claim 32, wherein a plurality of sets of said patches form a plurality of pyramidal waveguide structures.

40. The structure of claim 39, wherein said pyramidal waveguide structures repeat along an axis at a spacing.

41. The structure of claim 40, wherein said spacing is one half wavelength or less at an operating wavelength.

42. The structure of claim 39, wherein said pyramidal waveguide structures repeat along two orthogonal axes.
